(19) United States
(12) Patent Application Publication
(10) Pub. No.: US 2019/0007659 A1
(43) Pub. Date: Jan. 3, 2019

(54) SENSOR FOR SECURING A MACHINE

(71) Applicant: SICK AG, Waldkirch (DE)

(72) Inventors: Matthias NEUBAUER, Waldkirch (DE); Armin HORNUNG, Waldkirch (DE)

(21) Appl. No.: 16/007,000

(22) Filed: Jun. 13, 2018

(30) Foreign Application Priority Data
Jun. 28, 2017 (EP) 17178332.7
May 4, 2018 (EP) 18170726.6

(51) Int. Cl. H04N 7/18; G01B 11/14; H04N 13/271; H04N 13/239; G06T 7/73; G06T 7/593; H04N 13/296

(52) U.S. Cl. CPC H04N 7/183; G01B 11/14; H04N 13/271; H04N 13/239; G06T 2207/30232; G06T 7/593; H04N 13/296; G06T 2207/30196; G06T 2207/10028; G06T 7/73

(57) ABSTRACT

A safe optoelectronic sensor (10) is provided for securing a monitored zone (12) comprising at least one machine (26) that forms a hazard area (26a-b), wherein the sensor (10) has a light receiver (16a-b) for generating a received signal from received light from the monitored zone (12); a control and evaluation unit (24) for detecting object positions (28) in the monitored zone (12) from the received signal; and a safe output interface (30) for information acquired from the object positions (28). The control and evaluation unit (24) is here configured to determine the shortest distance between the hazard area (26a-b) and object positions (28) and to provide it at the safe output interface (30).

The invention relates to a safe optoelectronic sensor, in particular a 3D camera, for securing a monitored zone comprising at least one that forms a hazard area, wherein the sensor has a light receiver for generating a received signal from received light from the monitored zone; a control and evaluation unit for detecting object positions in the monitored zone from the received signal; and a safe output interface for information acquired from the object positions, and to a corresponding method of securing a monitored zone comprising at least one machine that forms a hazard area, wherein a received signal is generated and evaluated from received light from the monitored zone to detect object positions in the monitored zone, and wherein information acquired from the object positions is reliably output.

It is the primary goal of safety engineering to protect persons from hazard sources such as, for example, machines in an industrial environment represent. The machine is monitored with the aid of sensors and accordingly, if a situation is present in which a person threatens to come dangerously close to the machine, a suitable securing measure is taken.

3D sensors are inter alia used for the monitoring. They initially include 3D cameras in different technologies, for example stereoscopy, triangulation, time of flight, comprising evaluation of the interference of passive two-dimensional patterns or of projected illumination patterns. Such 3D sensors, in contrast to a conventional two-dimensional camera, record images that include a distance value in their pixels. These depth-resolved or three-dimensional image data are also called a depth map. Laser scanners are furthermore known that scan in two directions or in all three directions and that likewise detect three-dimensional image data over the respective scanning angles and the measured distance. The higher instrument and evaluation effort for generating three-dimensional image data in comparison with a two-dimensional image detection is justified by the additional information in a number of applications.

Sensors used in safety technology have to work particularly reliably and must therefore satisfy high safety demands, for example the EN13849 standard for safety of machinery and the machinery standard IEC61496 or EN61496 for electrosensitive protective equipment (ESPE). To satisfy these safety standards, a series of measures have to be taken such as a secure electronic evaluation by redundant, diverse electronics, functional monitoring or special monitoring of the contamination of optical components. It is typically required in safety technological applications that an object having a specific minimum size or specific minimum dimensions is reliably recognized. This property is called a detection capacity.

The common securing concept provides that protected fields are configured that may not be entered by operators during the operation of the machine. If the sensor recognizes an unauthorized intrusion into the protected field, for instance a leg of an operator, it triggers n safety directed stop of the machine.

There is an increasing desire for closer cooperation with persons (HRC, human-robot collaboration) in the safety engineering monitoring of robots. Relevant standards in this connection are, for example, ISO 10218 for industrial robots or ISO 15066 for collaborative robots. Protected fields and safety distances should be as small as possible in HRC and should possibly even be configured in a situation-adapted manner, naturally with the proviso that safety is maintained. Standards ISO 13854, ISO 13855, and ISO 13857 deal with the establishment of safety distances.

An evaluation of objects and machines with respect to speed and to mutual distance is called “speed and separation monitoring” in said robot standards. Safe monitoring sensors such as laser scanners or 3D cameras, however, do not support this. They still work with the typical protected fields and they only deliver a binary shutdown signal whether a protected field is infringed or not. Safety is admittedly ensured in this manner, but not particularly flexibly and also frequently with unnecessary safety overheads and thus restrictions of availability since the protected fields are configured for worst case scenarios and not the actual current situation.

EP 2 023 160 B1 deals with the configuration of protected fields in three-dimensional space. An intuitive and particularly well adapted definition of protected fields admittedly thereby become possible, but the safety approach per se remains the same.

To increase flexibility, dynamic protected fields are, for example, proposed in DE 101 52 543 A1 or DE 10 2004 043 514 A1 whose geometries are modified in dependence on machine movements or object movements. The direction and speed of objects is also determined in EP 2 395 274 B1 to adapt a protected field thereto. DE 10 2012 007 242 A1 monitors the environment of a robot and changes a projected field, called a hazard zone here, in dependence on properties of the detected objects. All these approaches using dynamic protected fields admittedly provide more flexibility, but it is a complex task to determine respective currently suitable protected field configurations in a reliable manner. In addition, the underlying protected field principle is naturally not changed that is only possible for a close human-robot cooperation with limitations.

EP 2 819 109 A1, for example, discloses a 3D sensor that recognizes object from a minimum size in a detection field. To correctly take account of the projective geometry of a stereo camera, regions of the depth map are compared with suitably selected templates. However, the object recognition takes place in a direct link with detection fields here. Objects outside detection fields are ignored. This is accordingly unsuitable for a safety concept not based on protected fields.

Whether the objects are located in dangerous proximity to the monitored machine also has to be evaluated beyond the simple object recognition. This is a demanding problem due to the additional depth dimension and shadowing effects.

The paper by Flacco, Fabrizio, et al. “A depth space approach to human-robot collision avoidance.” Robotics and Automation (ICRA), 2012 IEEE International Conference on. IEEE, 2012, calculates the distance from a robot starting from depth maps. The covering of objects is also named here; however, the covering by the robot itself is not taken into account. In addition, the distance calculation remains imprecise because work is carried out using spot beams without widening for simplification. If the detected object is closer to the camera than the robot, the spacing is calculated in the same depth plane and consequently only two-dimensionally. The distance is thus in particular overestimated with large aperture angles and in regions at the image margin and a reliable reaction is therefore not ensured.

Täubig, Holger, Berthold Bäuml, and Udo Frese. “Real-time swept volume and distance computation for self collision detection.” Intelligent Robots and Systems (IROS), 2011 IEEE/RSJ International Conference on. IEEE, 2011, calculate the convex envelope of different parts of a robot in motion for sphere-swept volumes. It is recognized via the distance of the volumes from one another whether the robot would collide with itself or with other machine parts in order then to trigger a stop. This paper does not look into collision recognition or distance calculation from objects or persons in the environment of the robot and, additionally, the projective covering in the camera geometry or in the depth maps detected thereby is not taken into account. The associated WO 2010/085944 A1 makes a corresponding disclosure.

Lenz, Claus, et al. “Fusing multiple kinects to survey shared human-robot-workspaces.” Technische Universität München, Munich, Germany, Tech. Rep. TUM-I1214 (2012) describe a system for sensor data fusion of a plurality of depth cameras. Foreground regions are extracted from their depth maps, the point clouds are fused, and finally, voxels in space that are clustered to form objects are calculated therefrom. However, only the visible object surfaces are processed. Non-visible regions are assumed to be free and are not taken into further account.

Equally in Miseikis, Justinas, et al. “Multi 3D Camera Mapping for Predictive and Reflexive Robot Manipulator Trajectory Estimation.” arXiv preprint arXiv:1610.03646 (2016), a collision map is formed in voxel space from the data of a plurality of sensors so that a robot evades where necessary. The projective covering is again not taken into account.

In the paper of Zube, Angelika, “Combined workspace monitoring and collision avoidance for mobile manipulators”, 2015 IEEE 20th Conference on Emerging Technologies & Factory Automation (ETFA), the information of a plurality of depth sensors is fused. The robot geometry, on the one hand, and the regions taken up and hidden by obstacles, on the other hand, are modeled by spheres between which a safety distance has to be maintained.

An industrial safety system is known from EP 2 947 604 A1 in which a time of flight camera records 3D image data. Objects detected therein are projected onto an XY plane and their distances are determined there. In a further embodiment, an object and a robot are each surrounded by a simple 3D body, for instance an ellipsoid, and the spacing between the envelopes is then calculated.

Kinematic parameters in an environment of a robot are determined in DE 10 2016 004 902 A1 to reduce a risk of collision. The expected movement of an object in the work space of a robot is forecast for this purpose. This only allows the largest and thus safety relevant instantaneous hazard to be recognized after some evaluation effort, in particular with a plurality of objects. Safety conforming to standard is also not achieved by using a simple kinect camera.

DE 20 2013 104 860 U1 discloses a working apparatus having an industrial robot in which an additional sensor determines a distance between the robot and an obstacle and a risk of collision is determined therefrom. It is not explained when an obstacle is to be considered relevant to safety, for example due to its size or other properties, in particular in the event of a plurality of objects that the additional sensor detects.

EP 2 386 876 B1 deals with a safe laser scanner whose protected field boundaries are configured from a polygonal line. The laser scanner calculates a distance from each edge of the polygon for objects detected outside protected fields in order optionally to output a warning that a protected field intrusion is impending. This is consequently no replacement for protected fields, but rather an addition that was previously reached by upstream warning fields. The actual safety function of this laser scanner is still exclusively based on a protected field monitoring.

In U.S. Pat. No. 8,249,747 B2, maps of a robot and a human are prepared with risk factors. It can thus be evaluated how dramatic the consequences would be of an accident with a collision of a specific region of a robot with a specific region of a human. The robot control should then avoid particularly dangerous accidents based on current sensor data using such risk profiles. A securing, however, typically wants to avoid collisions completely and not only make serious injury less probable.

In accordance with U.S. Pat. No. 9,043,025 B2, a robot reduces its work speed when an object is located in a surrounding detection zone. The detection zone is thus ultimately a kind of protected field with a milder response to a protected field infringement that does not result in a safety directed shutdown, but rather only in a slower work speed.

US 2015/0217455 A1 discloses a robot control on a presence of moving objects. The environment of the robot is monitored by means of a 3D camera to identify unexpected moving objects over a plurality of frames. If an unexpected object is recognized in a hazardous zone, the robot control reacts to avoid an accident. it is extremely complex to identify moving objects and to distinguish them from expected objects and the document does not look at all at how such an evaluation could be compatible with the relevant safety standards.

It is therefore the object of the invention to improve the monitoring of a machine, in particular on the basis of 3D image data.

This object is satisfied by a safe optoelectronic sensor for securing a monitored zone comprising at least one machine that forms a hazard area and by a corresponding method in accordance with the respective independent claim. The sensor is safe, that is, it is designed for a safety engineering application and satisfies the standards named in the introduction or corresponding standards from this to secure a hazardous machine. Received light from the monitored zone is detected by a light receiver and a received signal is acquired from it. The configuration of the light receiver and thus the kind of received signal depend on the sensor. The light receiver is an image sensor, for example, and the information read out of the pixels is called a received signal in sum. The received signal is evaluated in the sensor to detect object positions. Object positions are here generally to be understood as points of an object, not only as one position per object, that is, for example, a cloud of measurement points, in particular a 3D point cloud, or a depth map. The sensor additionally has an output interface, likewise called safe in the sensor of said standards or of comparable standards, to provide information acquired from the object positions. Conventionally, only a binary signal is output via such an output interface as to whether a protected field infringement is present (OSSD, output signal switching device).

The invention now starts from the basic idea of no longer monitoring protected fields and also no longer generating and outputting a binary securing signal itself. Instead, the information required for this is provided in a safe, very compact, and easily accessible manner. The shortest distance between the hazard area and the detected object positions is determined for this purpose. It takes account of all the objects in the monitored zone; the distance from the closest point of the closest object is consequently determined. The monitored zone here does not have to agree with the maximum detection zone, but can rather be restricted to a configured work zone. The respectively current shortest distance is provided for a connected control instead of the previously customary binary securing signal at the safe output interface, that is consequently no longer designed as an OSSD. This control, for instance the higher ranking control of a robot cell or also the control of the robot itself, can very simply determine with respect to the shortest distance whether there is a hazard and takes over the actual securing function itself.

The invention has the advantage that an efficient interface is provided between the sensor and thus the object recognition and the monitored machine for its securing which ensures the safety for humans at all times. The interface only requires a very little bandwidth since only one distance value per hazard area has to be transmitted. A distance value can preferably always only be transmitted when there are changes. It is easily possible to implement such an interface in accordance with existing safe industrial fieldbus protocols with today's industrial robots that would be completely overburdened with high data rates for instance for transmitting 3D point clouds.

In this respect, work or the cooperation with machines becomes substantially more flexible in design and a fast, individual response to humans in the environment of the machine is made possible. An intrusion into a protected field as a rule only allows an emergency stop since protected fields are defined exactly such that in such a case there is a risk of an accident that is no longer differentiated due to the binary shutdown signal. However, milder interventions in the process routine that avoid a time-intensive emergency stop together with a restart and that allow the process routine to continue to run without interference where possible or that integrate the approach of a human into the process routine are also possible by monitoring shortest distances. Worksteps of the machine can be replanned in good time here. Lost areas that are not usable for safety reasons, that is conventionally the protected fields and areas included by them, are minimized, which results in substantial savings and a substantially closer human-machine cooperation.

The sensor is preferably a 3D camera. A 3D camera can use any known technique such as a triangulation principle in which two camera images of a moving camera or of a stereo camera are correlated with one another or a camera image is correlated with a known projection pattern and disparities are estimated or a time of light principle with a direct time of flight measurement of light signals or phase measurement. A laser scanner also generates 3D point clouds that are restricted to one scanning plane with a classical laser scanner. This restriction with a laser scanner is lifted by a scan moving in elevation or by a plurality of scanning beams set into elevation.

A distance value and the shortest distance as the minimum of these distances are preferably determined for all the pars of hazard area positions and object positions. The respective calculations for the different pairs can be carried out successively and/or in parallel. It is also possible to restrict the pairs in advance. The pool of all the pairs is then formed by the restricted pairs. With a perspective of the detection known by the position of the sensor, a decision can be made very fast and without specific calculations under certain circumstances for some objects that they cannot be considered as objects with a shortest distance from the machine.

The control and evaluation unit is preferably configured to envelope the machine comprising at least one hazard area. According to current understanding, the machine itself is the hazard area. There are, however, various reasons not to use the physical dimensions of the machine directly as the hazard area. It can, for example, be sensible to surround areas of the machine with a buffer that takes account of occupied areas during the process routine or to except rigid machine parts from the hazard area from which no hazard emanates. A complex geometry of the machine can also be reduced to a simple geometry, for example a parallelepiped or a sphere, by the enveloping. The shortest distance is then possibly a little overestimated to simplify the modeling and the calculations which, however, does not impair safety, but only reduces the availability a little.

The sensor in accordance with the invention can preferably monitor a plurality of hazard areas. A plurality of machines are thereby monitored. There is additionally the possibility of considering different regions of the same machine as a plurality of hazard areas to detect all the relevant hazards by as few small and simple enveloping bodies as possible instead of requiring a single, unnecessarily large enveloping body. On a monitoring of a plurality of hazard areas, a shortest distance is preferably provided at the output interface for every hazard area to be able to observe the hazard situation separately.

The control and evaluation unit is preferably configured to ignore object positions within hazard areas. The hazard area itself is therefore considered free of objects to be detected or rather as blocked by the machine. There would actually absolutely be space for such objects depending on the enveloping body that models the machine as the hazard area. The machine naturally also itself forms an object that is first detected by the sensor. All this is, however, intentionally ignored and the hazard area is modeled as an empty block free of objects. This simplifies the monitoring and the determination of shortest distances since the dynamics of the machine within the hazard area thus does not play any role. This is also unproblematic from a safety engineering aspect since each object is recognized in good time when it approaches the hazard area.

The control and evaluation unit is preferably configured to monitor changing hazard areas, in particular for different machine states within a process routine. In principle, it would be conceivable, as already discussed, to define the hazard zone generously so that it covers all the machine positions during the process routine. Changing hazard areas can, however, remain a lot smaller since only those machine positions are covered that the machine can actually adopt while a specific changing hazard area is active.

The control and evaluation unit is preferably configured to provide at least one piece of additional information at the output interface, with the additional piece of information comprising at least one further shortest distance from other sections of the closest object or other objects, an object position, a direction of movement, a speed, an object envelope, or an object cloud. A differentiated evaluation is thus made possible for the connected control. It is, for example, conceivable that it is not a slow closest object that represents the greatest hazard, but rather a fast somewhat more remote object. The at least one additional shortest distance should relate to another object or to at least one clearly separate other object region such as another arm since otherwise only direct adjacent points from the shortest distance would be considered whose additional information contributes little new. Object positions are here preferably representative, for instance an object centroid or that object point from which the shortest distance was calculated, and not all the known object positions with respect to an object or its object point cloud. It is, however, also conceivable to output enveloping bodies with respect to the object or, however, the 3D point cloud of the object. All these pieces of additional information are preferably intermediate results that were anyway detected when locating the shortest distance or are parameters that can be very easily derived therefrom that do not substantially increase the effort.

The sensor is preferably configured for a detection capacity in which objects from a minimum size onward are detected, with only objects of the minimum size being considered for the determination of the shortest distance. The detection capacity is a specified suitability of a sensor that is safe in the sense of the introductory standards or comparable standards to securely detect objects of a minimum size in the total monitored zone. Only objects of the minimum size are considered for the determination of the shortest distance. The corresponding configuration of the sensor relates to its design, that is its optics, its light receiver, and further possible components, not yet named, such as lighting, and the secure evaluation. The detection capacity in the first instance does not preclude smaller objects from also being detected. However, protection is not guaranteed for objects that are smaller than the minimum size; for example, a finger is not reliably detected with a sensor designed for arm protection. Objects smaller than the minimum size are therefore possibly excluded in the evaluation by means of filtering. It is also possible to select a minimum size above the detection capacity, that is not to utilize a resolution provided per se. Numerical examples can be given as 10 mm for finger protection or in the range from 30-80 m for the protection of extremities, in particular 55 mm for upper arm protection.

The control and evaluation unit is preferably configured to define hazard areas in the form of at least one sphere covering the machine and/or to model objects as spheres having centers at the position of the object and radii corresponding to the minimum size corresponding to the detection capacity. This produces a certain underestimation of distances since the machine contour is not exactly replicated, but does very substantially facilitate the evaluation. The machine can be covered with practically any number of small buffer zones with a larger number of spheres of also different radii. It is not absolutely necessary to represent the total machine by spheres, but only the hazardous machine parts. Non-moving machine parts, regions that are inaccessible from a construction aspect, light or soft machine parts do not necessarily have to be secured. The acquisition of a suitable sphere representation is not the subject of this invention. It can, for example, be read directly from a machine control or robot control that knows or monitors the machine's own movement. It is also conceivable to identify the machine in the 3D image data and to cover it suitably with spheres. If the machine movement is reproducible, the sphere representation can be acquired in a preparatory step. The objects are also preferably modeled as spheres with centers at the position of the object and radii corresponding to the minimum size. If the object exceeds the minimum size in one dimension, correspondingly more such spheres are formed. The representation at the object side thus corresponds to the preferred sphere representation of the machine and permits a simplified evaluation. The object positions from which distances are determined are then no longer the measured object positions, but those of the spheres.

The control and evaluation unit is preferably configured to add the projective shadow of the hazard area and/or of the object to said hazard area and/or object for the determination of the shortest distance. When recording 3D image data from a position of origin corresponding to the position of the sensor, a detected object covers the region behind it. The shadowed region corresponds to the projection of the object starting from the position of origin into the distance and is therefore called a projective shadow. No decision can be made whether a further object is hidden there. The projective covering is therefore included in accordance with this embodiment and the projective shadow is added as a precaution to the detected object and/or to the machine part or to the hazard area, that is it is treated as if the project shadow were also a part thereof. At first glance, it appears necessary to add the projective shadow both to the object and to the machine part. It is also conceivable to do this. As explained further below, it is, however, also sufficient only to consider the projective shadow either for the machine part or for the object.

A reliable hazard recognition and in particular person recognition is made possible by taking account of the covering. As explained in the following, distances including covering can be efficiently calculated in an optimized routine, and indeed in particular in an inexpensive implementation on a CPU, embedded hardware, an ASIC (application-specific integrated circuit) or FPGA (field programmable gate array) or combinations thereof. The calculations are simple to parallelize since they are independent of one another for different pairs of machine parts/hazard areas and objects or part regions thereof. An efficient calculation can be provided that remains geometrically exact except for unavoidable numerical errors and it is ensured that the distance is at most slightly underestimated, but never overestimated. An error thus has at most slight effects on the availability and in no way impairs safety.

The control and evaluation unit is preferably configured to model project shadows as cones. The tip of the cone is the position of the object or of the hazard area and the cone jacket is produced by projective extension of beams that start at the position of origin. Provided that the object or machine part is modeled as preferred by spheres, the projective shadow is a truncated cone that is terminated upwardly in the direction of the position of origin by the sphere and the truncated cone is the exact associated projective shadow.

The control and evaluation unit is preferably configured only to add the projective shadow of the object to said object for the determination of the shortest distance when the object is closer to the sensor than the hazard area and conversely only to add the projective shadow of the hazard area to said hazard area when the hazard area is closer to the sensor. The projective shadow is accordingly only considered for the closer partner within a pair of object and hazard area. This is not an approximation, but a reduction of the distance. The non-considered shadow is always disposed at a larger distance, as results from geometrical considerations.

The control and evaluation unit is preferably configured to model the respective closer partner of a pair of hazard area and object in the form of first sphere together with a cone as a project shadow and to model the more remote partners as a second sphere for the determination of the shortest distance. In this respect, closer and more remote relate to the position of origin of the sensor. The problem is thus simplified to the distance determination between simple geometrical bodies. The result also remains correct when the more remote partner is likewise modeled by a cone, but the distance measurement does not thereby become more exact and becomes unnecessarily complex.

The more remote partner is preferably first considered as a point during the distance determination and it is later compensated by deducting the radius of the second sphere. This further facilitates the calculation that remains exact in this respect due to the spherical properties.

The control and evaluation unit is preferably configured to use a sectional plane that is defined by the position of the sensor, the center of the first sphere, and the center of the second sphere for the determination of the shortest distance. The three points define an unambiguous plane in which all the relevant information can still be represented. The distance determination thus becomes only a two-dimensional problem that is substantially better to deal with. The center of the first sphere and the center of the second sphere are preferably projected into the spherical plane while the position of origin also forms the coordinate origin for computing simplification without restricting the general application.

A tangent from the position of origin to a projection of the first sphere into the sectional plane is preferably looked at in the sectional plane. The tangent is looked at, the calculations therefore start from the model representation of such a tangent, an actual calculation or even representation of the tangent is in contrast not necessary. The projection of the first sphere produces a circle. There are actually two tangents through the position of origin at this circle that can also both be considered, but do not have to be, since, as explained in the next paragraph, always only one tangent is considered for the sought distance.

Only that tangent is preferably considered that is closer to the center of the second sphere. This appears to be a banal demand at first glance that is, however, not easy to satisfy since the more remote tangent can naturally not deliver the sought shortest distance; it is, however, not known a priori which is further remote. In fact, however, the closer and more remote tangents are immediately distinguishable by means of their gradient behaviors; the closer tangent in particular always has a negative gradient and the more remote tangent always has a positive gradient in the specific coordinates of the embodiment explained further below.

A distinction is preferably made with reference to the perpendicular from the center of the second sphere to the tangent whether the shortest distance from the first sphere or from its projective shadow is present. A case by case analysis is accordingly made whether the sphere modeling the object or machine part itself or its projective shadow has the shortest distance. The distinction criterion is whether the foot of the perpendicular is disposed behind or in front of the contact point of the tangent with the circle. If the sphere itself is decisive in accordance with the case by case analysis, the spacing of the centers is formed with a deduction of the radii. If it is the projective shadow, the distance between the center of the second sphere and the already known foot of the perpendicular to the tangent is used.

An arrangement of at least one sensor in accordance with the invention and a control is preferably provided that is connected to the output interface and to the secured machine, with the control being configured to evaluate shortest distances provided by the sensor and to initiate a safety directed response where necessary. The control is superior to the sensor and to the monitored machine or machines or it is the control of the machine itself. The control upgrades the distances delivered by the sensor and initiates a safety directed response where necessary. Examples for a securing are an emergency stop, a braking, an evading, or a putting into a safe position. It is conceivable to specify a fixed minimum distance that is, for instance, determined under worst case assumptions for speeds or from known or measure trailing distances. Dynamic safety distances, inter alia in dependence on the current speed of the machine and of the object, are also conceivable. Data of the control can flow into the safety evaluation.

The arrangement preferably has a plurality of sensors whose monitored zones and/or perspectives complement one another. The object positions are thus determined from at least two positions of origin. It is a possible advantage to detect a monitored zone that is larger overall by mutual complementing. In addition, different perspectives are helpful in that distances are first determined separately with the different projective shadows in overlapping regions and a common shortest distance is subsequently found. The invention admittedly takes account of the covering in a reliable and appropriate manner, but cannot cancel out the monitoring restriction due to covering per se. On a recording from a plurality of perspectives, the projective shadows disappear or at least become considerably smaller after a common evaluation. To keep this common evaluation particularly simple, the distances are first separately determined in the object positions from different positions of origin and the shortest distances are only subsequently sought. The evaluation remains decoupled, parallelizable, and easy to handle in this manner. In principle, object positions or received signals, in particular 3D point clouds, could also be fused earlier in the processing chain and the projective shadows could thereby be directly eliminated or reduced in size. This is, however, immeasurably more complex.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

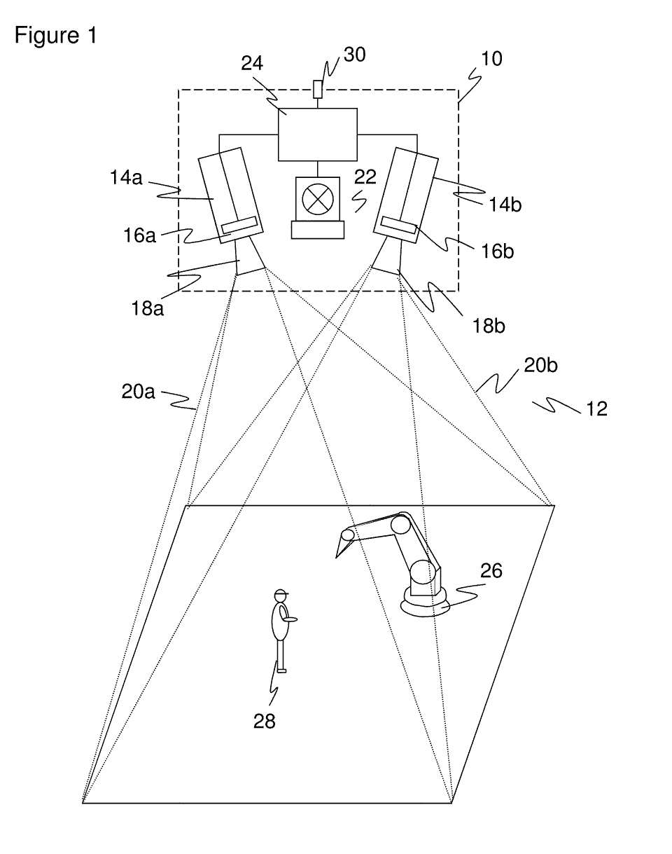

FIG. 1 a schematic three-dimensional representation of a 3D camera and its monitored zone;

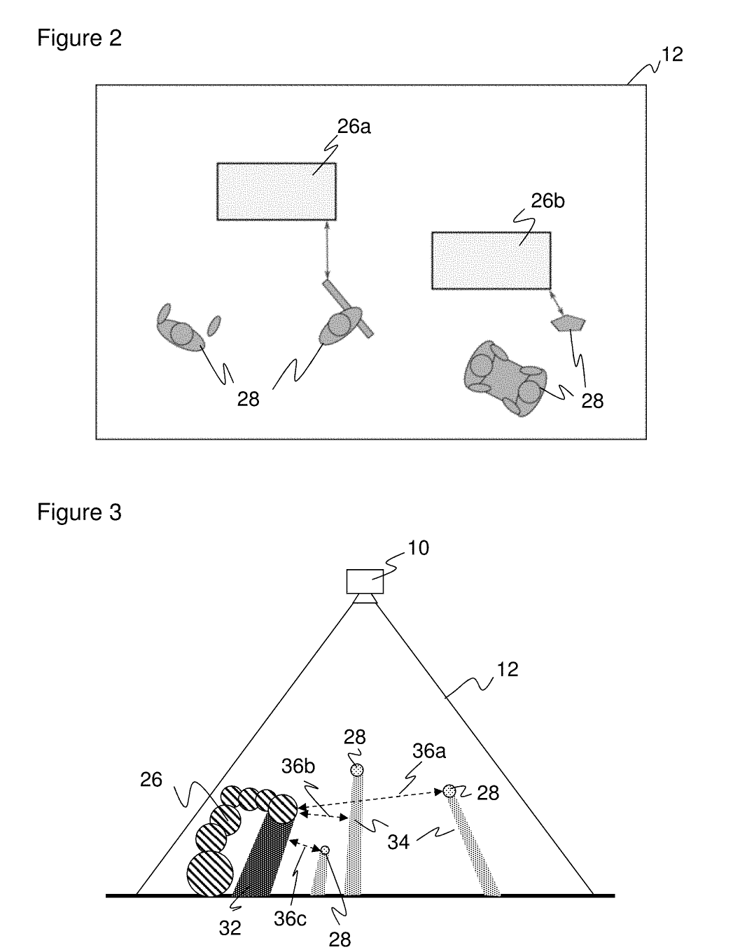

FIG. 2 an exemplary monitoring situation with a plurality of hazard areas and objects;

FIG. 3 a schematic representation of the monitored zone with machine parts and objects modeled as spheres and their projective shadows;

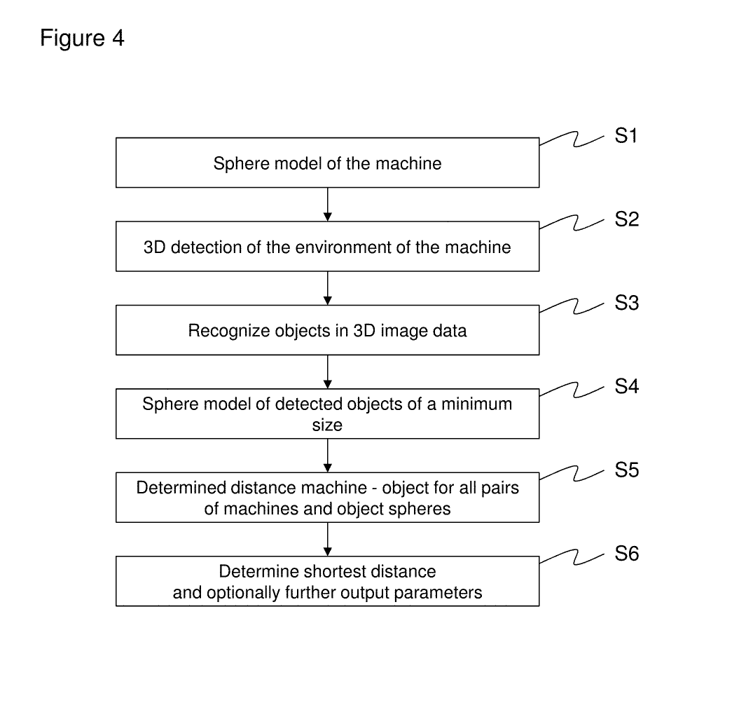

FIG. 4 an exemplary flowchart for evaluating the positions of objects at machine parts;

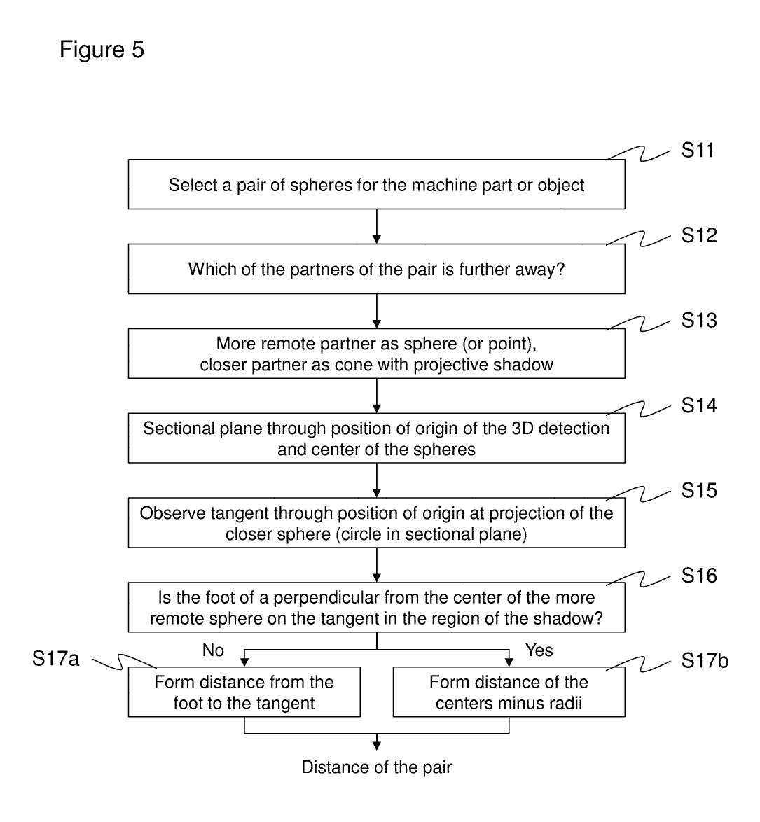

FIG. 5 an exemplary flowchart for determining the distance between an object and a machine part while taking account of projective shadows;

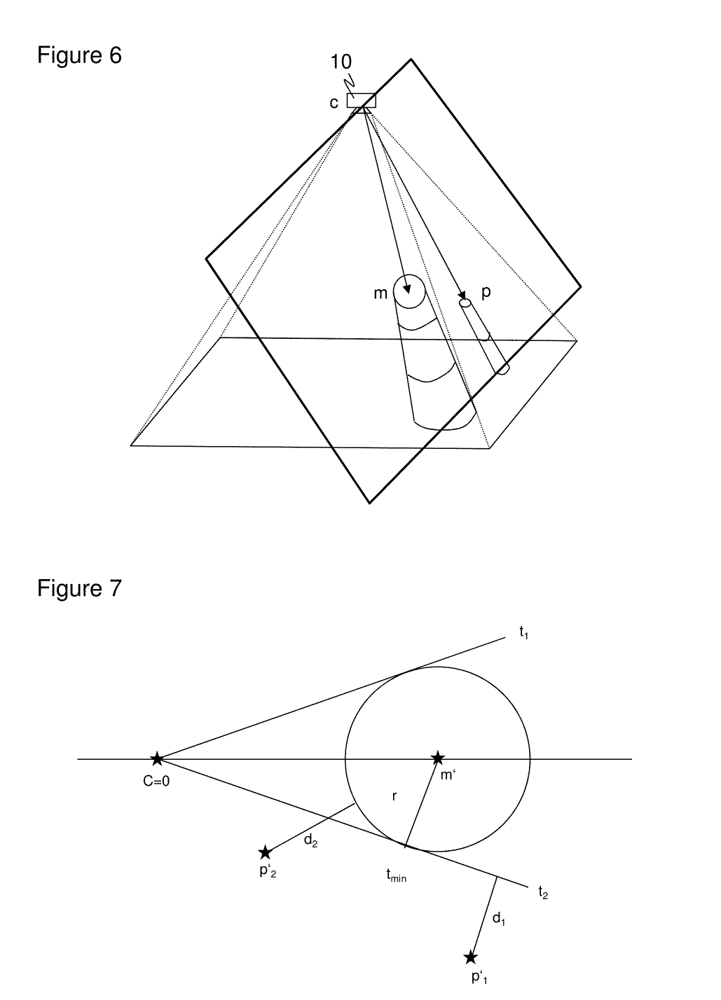

FIG. 6 an explanatory sketch of a sectional plane for calculating the distance; and

FIG. 7 a further explanatory sketch for calculating the distance within the sectional plane.

FIG. 1 shows the general design of a stereo camera 10 for recording a depth map in a schematic three-dimensional representation. The stereo camera 10 is only an example for a sensor in accordance with the invention with reference to which the detection of 3D image date will be explained. The other 3D cameras named in the introduction would equally be conceivable with determination of the time of flight or an evaluation of the interference of passive two-dimensional patterns or with correlation of image and projected illumination patterns and laser scanner.

Two camera modules 14a, 14b are mounted at a known fixed distance from one another therein and each take images of a spatial zone 12 to detect the spatial zone 12. An image sensor 16a, 16b, usually a matrix-type recording chip, is provided in each camera and records a rectangular pixel image, for example a CCD or a CMOS sensor. The two image sensors 16a, 16b together form a 3D image sensor for detecting a depth map. One objective 18a, 18b having an optical imaging objective is associated with each of the image sensors 16a, 16b respectively which in practice can be realized as any known imaging lens. The maximum angle of view of these optics is shown in FIG. 1 by dashed lines which each form a pyramid of view 20a, 20b.

An illumination unit 22 is provided between the two image sensors 16a, 16b to illuminate the spatial zone 12 with a structured pattern. The stereo camera shown is accordingly configured for active stereoscopy in which the pattern also imparts evaluable contrasts everywhere to scenery that is structure-less per se.

Alternatively, no illumination or a homogeneous illumination is provided to evaluate the natural object structures in the spatial one 12, which as a rule, however, results in additional image defects.

An evaluation and control unit 24 is associated with the two image sensors 16a, 16b and the lighting unit 22. The control and evaluation unit 24 can be implemented in the most varied hardware, for example in digital modules such as microprocessors, ASICS (application specific integrated circuits), FPGAs (field programmable gate arrays), GPUs (graphics processing units) or mixed forms thereof that can be distributed over any desired internal and external components, with external components also being able to be integrated via a network or cloud provided that latencies can be managed or tolerated. Since the generation of the depth map and its evaluation is very computing intensive, an at least partly parallel architecture is preferably formed.

The control and evaluation unit 24 generates the structured illumination pattern with the aid of the illumination unit 22 and receives image data of the image sensors 16a, 16b. It calculates the 3D image data or the depth map of the spatial zone 12 from these image data with the aid of a stereoscopic disparity estimate. The total detectable spatial zone 12 or also the working region can be restricted via a configuration, for example to mask interfering or unnecessary regions.

An important safety engineering application of the stereo camera 10 is the monitoring of a machine 26 that is symbolized by a robot in FIG. 1. The machine 26 can also be substantially more complex than shown, can consist of a number of parts, or can actually be an arrangement of a plurality of machines, for instance of a plurality of robots or robot arms. The control and evaluation unit 24 checks where an object 28, shown as a person, is located with respect to the machine 26. A smallest distance of an object 28 from the machine 26 is output via a safe interface 30, either directly to the machine 26 or to an intermediate station such as a safe control. The stereo camera 10 is preferably failsafe in the sense of safety standards such as those named in the introduction.

The control connected to the safe interface 30, either a higher ranking control or that of the machine 26, evaluates the shortest distance. In the hazard case, a safety directed response is initiated in order, for example, to stop or brake the machine 26 or to cause it to evade. Whether this is necessary can depend, in addition to the shortest distance, on further conditions such as the speeds or the nature of the object 28 and the machine zone 26 of the impending collision.

It will now be described in detail in the following how a distance monitoring is made possible with the sensor 10, for example for a human-robot collaboration while considering DIN EN ISO 10218 or ISO/TS 15066. The starting point is formed by the positions of the machine parts of the machine 26, at least to the extent that they are safety relevant, or by hazard zones defined on this basis and optionally expanded with reference to response and stopping times or other criteria and by the objects 28 detected by the stereo camera 10. The latter is, for example, present in the form of a 2D detection map whose pixel at positions in which an object 28 of a minimum size was detected, the distance value measured for this purpose is entered and otherwise remains empty. The respective distance, and in particular the shortest distance, from the machine 26, that forms a hazard area that is preferably also dynamic is calculated with the aid of these object detections that can naturally also be differently represented. Depending on the distance, a securing then takes place, optionally by a control connected to the safe interface 30, that can, as mentioned multiple times, also comprise an evasion or a slowing down.

FIG. 2 shows a monitoring situation in the monitored zone 12. The securing task on the basis of the sensor 10 then comprises recognizing the presence of persons, here simply defined as objects 28 of a specific minimum size, and initiating a defined response in a safety directed manner in dependence on their position and optionally on further parameters and the current machine state so that the safety of the humans is ensured at all times.

In this example, two hazard areas 26a-b have to be monitored, that is machine zones or machines, and four objects 28 are currently recognized in their environment by the sensor 10. Two of the objects 28 are individual persons, without the sensor 10 having to explicitly acquire this information; a further object 28 comprises two persons fused together, either because they are carrying a workpiece together and are so actually connected or because the segmentation was unable to separate the two persons. There is additionally another object 28 that cannot be identified in any more detail and could be article or a false detection. If it is beneath the minimum size, it can be ignored; otherwise it must be recognized as a person as a precaution. The non-connected arm of the person at the far left forms, in dependence on the evaluation, a separate further object or is attributed to the person, in particular according to the teaching of EP 3 200 122 A1. The sensor 10 delivers distance data so that a connected control protects the persons from injury by reduced speed, an evasive replanning of the routines, or where necessary a stop of the machines in the hazard areas 26a-b in good time.

A hazard area 26a-b is a preferred modeling of the hazardous machine 26. The hazard area 26a-b is a spatial zone in which the machine 26 carries out work movements in a respective time period. The hazard area 26a-b can surround the machine 26 with a little spacing to leave sufficient clearance for the work movements. In addition, it is advantageous for the calculations to geometrically define simple hazard areas 26a-b such as parallelepipeds or spheres, for which purpose certain empty spaces can then be accepted. A plurality of hazard areas 26a-b surround a plurality of machines 26 and/or a plurality of moving part sections of a machine 26. Hazard areas 26a-b can be rigid and can comprise all conceivable work movements. Alternatively, respective hazard areas 26a-b are defined for part sections of the work movement that are utilized in a sequence corresponding to the process and that are smaller and are better adapted.

The control and evaluation unit 24 continuously calculates the shortest distance of the object 28 closes to a respective hazard area 26a-b. Arrows are drawn in FIG. 2 that in the current situation of FIG. 2 represent the two shortest distances with respect to the two hazard areas 26a-b. The shortest distance connects the closest point of a hazard area 26a-b to the closest point of the next object 28. It is assumed in this representation that the smaller object 28 at the bottom right exceeds the minimum size. It would otherwise be ignored and instead the distance from the two fused persons who form the second-closest object 28 would be output.

The respective shortest distance last determined with respect to a hazard area 26a-b is provided cyclically or acyclically at the safe interface 30. Typical output rates are multiple times a second; however, a more infrequent updating is also conceivable depending on the required and possible response time of the sensor 10. A higher ranking control connected to the safe interface 30, in particular that of the machine 28, plans the next workstep again, where necessary in dependence on the shortest distance, so that the required safety distance between human and machine is always maintained.

The control and evaluation unit 24 preferably also determines a speed of the object 28 from which the shortest distance was measured and outputs it with the shortest distance at the safe interface 30. The hazard can thus be differentiated even better. The closest object 28 is admittedly the most dangerous as rule—or in more precise terms the one most at risk. The safety distance that the machine 26 maintains on its movement planning can additionally be adapted to a maximum speed of a human movement. The safety directed response of the machine is nevertheless best adapted to its environment if more information is present on the closest object 28 and possibly also on further objects 28. A dependence on the machine's own status and on the planned movement of the machine 26, in particular the position and speed of machine parts or even of dangerous tool regions, is also conceivable, with such information preferably being provided by the machine control.

There are a number of further measurement parameters or of parameters derived therefrom that the control and evaluation unit 24 can output in addition to the shortest distance at the safe interface 30 so that they can enter into the safety observation of the control connected there. The speed of the closest object 28 from which the shortest distance is measured has already been discussed.

Additional shortest distances from further objects 28 or from separate object sections of the closest object 28 are preferably output, for example of a different arm. A possible criterion here would be that there are even further local distance minima in the same object since the direct adjacent points from the shortest distance are of no interest. For example, the sensor 10 guarantees the monitoring of the five closest distances per active hazard area 26a-b. A sixth object and further objects or object sections are no longer considered, with an additional piece of information being conceivable, however, that there are more than five objects of the minimum size in the monitored zone 12. The connected control can thus also pre-plan for further future danger situations with other objects 28 than the closest object 28. A graphic example is a still somewhat more remote object 28 that approaches a hazard area 26a-b at high speed.

Further conceivable additional pieces of information are, non-exclusively, the size of the closest object 28, its position in the form of a centroid or of the closest point, a direction of movement, an object envelope, an enveloping body surrounding the object 28 or a representation of the object 28 in total as an object cloud, 3D point cloud, or 3D voxel representation.

A safety application using the sensor 10 in accordance with the invention can be described as follows. This routine is only an example. First, after a suitable installation of the sensor 10, for example with a bird's eye view above the machine 26 to be secured, the hazard areas 26a-b are configured. Alternatively, a sensor combination is installed to acquire an additional field of vision and/or further perspectives. The configuration itself expediently takes place by a set-up engineer in a corresponding software tool, with AR-like configurations, however, also being conceivable directly in the work space similar to EP 2 023 160 B1 named in the introduction where protected fields are configured in this manner. It is conceivable to configure a further set of hazard areas 26a-b in dependence on the process step of the machine 26.

The sensor 10 then detects the objects 28 that are respectively located in the monitored zone 12 in operation. The recorded depth maps are filtered with the hazard areas 26a-b that are themselves not monitored and are optionally filtered with taught background objects. Small interference objects and gaps in which no depth values are detectable are ignored. The control and evaluation unit 24 segments the depth map in a manner not explained in any more detail here to separate the objects 28. There are numerous examples in the literature on such segmentations.

The distance between each hazard area 26a-b and each object 28 is then determined. The distance between each object position, i.e. each object point and each point of a hazard area 26a-b, generally has to be determined for this purpose. However, more effective processes can be used, for instance by means of enveloping bodies, so that it is not necessary really to observe every point, and heuristics can also be used that quickly exclude some objects as not to be considered. A particularly effective method of locating the shortest distance will be provided further below.

Depending on the embodiment, the control and evaluation unit 24 determines further parameters in addition to the shortest distance, such as the speed of the object having the shortest distance or shortest distances from further objects 28. The shortest distance and any additional pieces of information are provided to the safe interface 28.

If a plurality of sensors 10 are used in a combination, a higher ranking control connected to the respective safe interfaces 30 reads the provided data and fuses them. If the sensors 10 are initially calibrated to a common global coordinate system, this fusion is very simple since only the shortest distance over all sensors 10 has to be selected from the shortest distances per hazard area 26a-b delivered locally per sensor 10.

The higher ranking control or a machine control directly connected to the safe interface 30 uses the shortest distances per hazard area 26a-b thus acquired to determine whether a replanning of the current workstep or of a future workstep is required so that the process runs ideally and safety is ensured. The safety directed response only comprises a shutdown of the machine 26 in emergencies.

The determination of the shortest distances in the control and evaluation unit 24 preferably takes place while taking account of the projective geometry in 3D space. Alternatively, a 2D projection onto the sensor image plane, onto a ground plane, or onto an intermediate plane would also be conceivable.

An advantageous particularly efficient sphere model for distance calculation will be presented in the following that considers projective shadows. For this purpose, FIG. 3 shows a schematic side view of the spatial zone 12 monitored by the stereo camera 10. FIG. 4 shows an exemplary flowchart for evaluating the position of objects 28 with respect to the machine 26 to be monitored in rough steps. It preferably takes place in each frame of the 3D image data detection or at least at a frequency that ensures a required safety directed response time.

In a step S1, the machine 26 is represented by enveloping spheres for the further evaluation for a simplified handling. These spheres cover the machine 26 or at least those machine parts that form a hazard source to be monitored or the hazardous volume derived therefrom, that is the hazard area 26a-b. In this respect a consideration must be made between the effort for the monitoring and the accuracy of the approximation for the number of spheres. In some embodiments, the sphere representation is supplied to the control and evaluation unit 24 via an interface, for example from other sensors or from a control of the machine 26 that knows or monitors its own movement. The space taken up by the machine 26, including its projection onto the image plane of the stereo camera 10, is preferably masked and not observed to avoid the machine 26 itself being recognized as an object 28.

In a step S2, the spatial zone 12 is now recorded by the stereo camera 10 to acquire 3D image data. In some embodiments, the machine 26 is recognized in the 3D image data and a sphere representation is derived therefrom provided that these data are not made available elsewhere. The sequence of the steps S1 and S2 is then preferably reversed.

In a step S3, objects 28 of the minimum size are detected in the 3D image data. They are then known with their 3D position, for example in the form of a detection map as described above.

The objects 28 or their surfaces that are visible from the point of view of the stereo camera 10 are likewise modeled as a sphere in a step S4. For example, each position in the detection map at which a distance value is entered and accordingly an object 28 of the minimum size is detected there is enveloped with a sphere having a radius corresponding to the minimum size. A plurality of adjacent pixels are occupied by a distance value for objects 28 that are larger than such a sphere in the detection map so that spheres arise there that are nested in one another and that ultimately envelope the object as a whole. It is possible in an intermediate step to eliminate those spheres that are covered by other spheres and thus do not have to be evaluated.

In a step S5 that will be explained more exactly with reference to FIGS. 5 to 7, the stereo camera 10 then calculates the distances between the machine 26 and the objects 28, in particular the shortest distance, to be able to use it for a safety directed response of the machine 26. Consequently, distances have to be calculated between spheres representing the machine 26 and objects 28.

However, this is not yet sufficient for a safe evaluation due to the projective covering from the point of view of the stereo camera 10. A further object that is not detectable for the stereo camera 10 can be hidden in the shadow 32 of the machine 26 or in the region masked for this purpose or equally in the shadow 34 of the objects. For reasons of safety, the respective shadow 32, 34 is treated as an object 28 or as a part of the machine 26. The projective shadow, that is the region covered from the point of view of the stereo camera 10, is a truncated cone for a sphere, with the truncated cone being formed by beams emanating from the stereo camera 10.

The machine 26 and the objects 28 thus become spheres having a transition into a truncated cone. Different reference points then result for the shortest distance, in dependence on the position of the objects 28 with respect to the machine 26, for example a distance 36a between the machine 26 and an object 28, a distance 36b between the machine 26 and a shadow 34 of an object 28, and a distance 36c between a shadow 32 of the machine 26 and object 28, and also a distance, not drawn, between the shadows 32, 34 would be conceivable.

In a step S6, the distances calculated for all the pairs are evaluated together, in particular the shortest distance is determined as the minimum. The pairs can also be restricted in advance. As can be seen, the object 28 at the far right in FIG. 3 cannot have the shortest distance from the machine 26. It is possible to have heuristics or processes upstream to restrict the number of pairs and thus the effort.

A possible output parameter, and one that is particularly important in a number of cases, is the shortest distance since a typical safety observation requires that a certain distance is always observed between the machine 26 and objects 28. There can, however, also be other or further output parameters. For example, the n shortest distances from the machine 26 are calculated and output to evaluate a plurality of objects 28 or object regions. It is similarly possible to calculate and output shortest distances from a plurality of part regions of the machine 26 or from a plurality of machines in parallel. There is no basic difference between an individual machine 26 and a plurality of machines or hazard areas due to the sphere representation. It is, however, conceivable that different machine zones are treated differently, for instance due to a degree of danger. The coordinates, that is the affected regions of the machine 26 or objects 28 together with an approximated geometry or a geometry detected in the 3D image data, the contact points of the distance line, or the distance line itself can also be output with respect to a distance. The speeds of the involved regions of the machine 26 and objects 28 can also be determined from at least a plurality of frames of the 3D detection by object tracking, for instance. Such parameters can be relevant and can be calculated and output in any desired combination depending on a subsequent safety observation.

FIG. 5 shows an exemplary flowchart with efficient individual calculation steps for the calculation of the distance for a pair of spheres with respective truncated cones. It can consequently be understood as a specific embodiment possibility of step S5 of the flowchart shown in FIG. 4.

In a step S11, a pair of spheres is selected for the machine 26 and an object 28 whose distance is to be calculated while considering the projective shadow 32, 34. The complete calculation remains geometrically correct; apart from unavoidable numerical inaccuracies, no approximation takes place.

The respective enveloping spheres are converted into suitable global coordinates, Cartesian coordinates here, with the aid of a calibration of the 3D camera. The spheres are associated with a truncated cone to take the projective shadow into account. That is consequently the input parameters of a single distance determination: Two geometrical bodies that can be illustrated as a sugarloaf and that comprise a spherical segment with an adjoining cone or truncated cone and that are completely described geometrically by a center and a radius, while adding the position of the stereo camera 10 and the fact that the projective shadows 32, 34 in the distance extend in principle into infinity and practically up to and into the maximum range of the stereo camera 10.

In a step S12, a simplification is done for the further calculation: A check is made which of the two partners of the pair is further remote from the stereo camera 10, with respect to the respective center. The center of the closer partner is marked by m; the center of the more remote partner by p. It must be noted that m,p no longer allow the recognition by these determinations whether the machine 26 or the object 28 is located there; the geometrical distance problem is independent of this.

In step S13, the cone is now omitted with the more remote p. This is sufficient because the cones representing projective shadows 32, 34 each arise in projection from the point of view of the stereo camera 10 and the distances from the stereo camera 10 thus become larger and larger. In other words, it is therefore impossible that the shortest distance is from the more remote shadow 32, 34. In addition, it is sufficient to consider p as a point in the further calculation. The sphere can namely be taken into account very simply by deducting its radius from the calculated distance. With the closer m, in contrast, it is still the sphere that is associated with a truncated cone.

In a step S14, the three-dimensional problem is now projected onto a two-dimensional problem. FIG. 6 illustrates how a sectional plane is placed through the three points c, m, p for this purpose. Here, c is the position of the stereo camera 10 that is placed without restriction of general applicability into the coordinate origin, c=(0,0,0)^{T}.

This sectional plane should now be detected. Since it passes through the origin c, the plane equation is n₁x+n₂y+n₃z=0 with the plane normal n=m×p. A coordinate system of two normal vectors e₁, e₂ is determined in the sectional plane. The following division is advantageous for the further calculation in this respect:

$${e}_{1} = \frac{m}{‖ m ‖} , \\ {e}_{2} = \frac{ɛ}{‖ ɛ ‖} , \\ ɛ = m \times n = m \times ( m \times p ) = m ( m \cdot p ) - p {‖ m ‖}^{2} .$$

The two normal vectors e₁, e₂ therefore span a Cartesian coordinate system within the sectional plane, with e₁ in the direction m and e₂ perpendicular thereto.

A 2×3 projection matrix can then be formed from the two vectors that projects m, p into the 2D sectional plane: m′=(m, 0)^{T}, c′=(0,0)^{T} and p′ from the projection with the projection matrix E: p′=E p with

$$E = ( \begin{matrix}{e}_{1}^{T} \\ {e}_{2}^{T}\end{matrix} )$$

or p′ₓ=e₁p and p′_{y}=e₂p.

FIG. 7 illustrates the situation in the sectional plane. The sphere around m becomes a circle around m′ with a radius r and the covering cone is defined by the tangents t₁, t₂ at a circle through the origin c that represent the cone surfaces in the sectional plane.

In a step S15, these tangents are looked at. The tangent equations in gradient form are

$${t}_{1 , 2} \text{:} y = {s}_{1 , 2} x ⇒ {s}_{1} = \frac{y}{x} = tan α due to symmetry \text{:} {s}_{2} = - {s}_{1} )$$

$$with = sin ( \frac{r}{m} ) ⇒ {s}_{1} = tan ( a sin ( \frac{r}{m} ) ) = \frac{r / m}{\sqrt{1 - {r}^{2} / {m}^{2}}} .$$

let

$$γ := \frac{m}{r}$$

be the ratio or the camera distance from the radius r, γ≥1.

The gradient of the tangents is then

$${s}_{1 , 2} = \pm \frac{1}{\sqrt{{γ}^{2} - 1}}$$

and the tangent equation is thus

$${t}_{1 , 2} \text{:} y = \pm \frac{1}{\sqrt{{γ}^{2} - 1}} x .$$

The closest point on the tangent from the point p or its parameterization along the tangent is specifically required. Two different points p′₁, p′₂ are shown in FIG. 7 that correspond to different possible locations of p.

The Hesse normal form with which the distance of a point p′ from the straight line can be calculated can be simply derived from the point gradient shape of the tangent equation. However, the closest point on the straight line to p′=(pₓ, p_{y})^{T} is also required here (“perpendicular foot”), the vector form is more practical for this purpose.

It follows from the tangent equation ±x=\sqrt{γ²−1}y and thus the respective directional vector

$${a}_{1 , 2} = ( \begin{matrix}\sqrt{{γ}^{2} - 1} \\ \pm 1\end{matrix} )$$

for the tangents.

The tangent equation in vector form describes any desired point on the straight line over the free parameter t, in particular also two potential perpendicular feet l_{1,2}:

$$( \begin{matrix}x \\ y\end{matrix} ) = t ( \begin{matrix}\sqrt{{γ}^{2} - 1} \\ \pm 1\end{matrix} ) .$$

The vectors b_{1,2}:=p′→l_{1,2} are the connection vector from p′ to the perpendicular foot of each tangent:

$${b}_{1 , 2} = ( \begin{matrix}\sqrt{{γ}^{2} - 1} \cdot t \\ \pm t\end{matrix} ) - {p}^{′} .$$

The perpendicular must be upright on the directional vector, i.e. aᵢ·bᵢ=0 for i=1, 2.

The following solutions for t result from this:

$${t}_{1 , 2} = \frac{{p}_{x} \sqrt{{γ}^{2} - 1} \pm {p}_{y}}{{γ}^{2}} .$$

p′ is now always in the negative y/positive x quadrant due to the coordinate system spanned by e₁, e₂, which also results from the order of the vectors in the cross product. However, this means that the descending tangent t₂ is always the closer. The tangent t₁ is preferably not observed, which facilitates the calculation in operation.

In addition, due to the filtering of depth values in the preprocessing, there is no object 28 in the machine 26 or its shadow; corresponding detections are masked. It can therefore be precluded that p is located in the cone. In addition, all the parameters are restricted to the range of valid depth values; that is they lie in the monitored spatial zone 12.

After the calculation of

$$t = \frac{{r}^{2}}{{m}^{2}} ( {p}_{x} \sqrt{\frac{{m}^{2}}{{r}^{2}} - 1} - {p}_{y} ) ,$$

the values are compared with the minimum permitted values. They define the valid region of the cone jacket.

The minimal value tₘᵢₙ for the tangent results by inserting the circle center into

$$\text{?} = ( \begin{matrix}m \\ 0\end{matrix} ) \text{:} {t}_{min} = \frac{{r}^{2}}{m} \sqrt{\frac{{m}^{2}}{{r}^{2}} - 1} . \\ \text{?} \text{indicates text missing or illegible when filed}$$

In a step S16, a case by case analysis is now carried out. Depending on which of the shown points p′₁, p′₂ corresponds to the location of p, the shortest distance is from the tangent or from the circle. As is clear, the tangent corresponds to the shadow 32, 34 and the circle corresponds to the machine 26 or to the object 28 itself.

t>tₘᵢₙ applies to a point in a location such as p′₁ and then the perpendicular foot l is calculated from the tangent equation in a step S17a. The distance results from d=∥l−p′∥. It is transformed back into 3D coordinates via the plane vectors, l_{3D}=E^{T}l with E^{T}=(e₁ e₂) or l_{3D}=lₓe₁+l_{y}e₂, where lₓ,l_{y} are the coordinates of the closest tangent point. The radius of the sphere around p still has to be deducted for the actual distance to compensate the reduction of the sphere there to a point.

If conversely t≤tₘᵢₙ for a point is in a location such as p′₂, the circle is directly used instead of the tangent in a step S17b. The distance then simply corresponds to the distance of the centers m, p after deduction of the radii of both spheres in this case.

The distance of the pair is thus known in an exact geometrical calculation while taking account of the projective shadows.

In many cases, the movement of the machine 26 is not completely free and dynamic, but is rather largely known at the setup time. The control and evaluation unit 24 then does not have to look at the distance at the run time again, but can rather calculate in advance the distances from a number of positions or from all possible positions in the spatial zone 12, for instance in a discretized form of 2D pixel addresses and a depth value, for a series of known configurations. A look-up table is thus produced in a configuration phase that permits a very fast evaluation at the run time.

In a further embodiment, the machine 26 is not considered with its covering cone; for example, because the safety concept does not require it. The machine 26 is then considered as a free-floating sphere and the object 28 as a sphere with a covering cone. If then all the spheres are still the same size, calculation can be more efficient with the squared distance and the laborious taking of roots is omitted.

A further embodiment not only provides one stereo camera 10, but rather a combination of a plurality of stereo cameras 10. It must be remembered that the stereo camera 10 is only an exemplary sensor and such a combination can also be inhomogeneous, i.e. can have different sensor types. Each sensor determines the shortest distance for it with the projective covering applicable to it. The distances are evaluated in combination in that, for example, the shortest distance from the combination is used for the safety directed evaluation.

1. A safe optoelectronic sensor for securing a monitored zone, the monitored zone comprising at least one machine that forms a hazard area, the safe optoelectronic sensor having:
a light receiver for generating a received signal from received light from the monitored zone;
a control and evaluation unit for detecting object positions in the monitored zone from the received signal; and
a safe output interface for information acquired from the object positions, wherein the control and evaluation unit is configured to determine the shortest distance between the hazard area and object positions and to provide the shortest distance at the safe output interface.

2. The safe optoelectronic sensor in accordance with claim 1, wherein the safe optoelectronic sensor is a 3D camera.

3. The safe optoelectronic sensor in accordance with claim 1, wherein the control and evaluation unit is configured to envelope the machine comprising at least one hazard area.

4. The safe optoelectronic sensor in accordance with claim 1, wherein the control and evaluation unit is configured to ignore object positions within hazard areas.

5. The safe optoelectronic sensor in accordance with claim 1, wherein the control and evaluation unit is configured to monitor changing hazard areas.

6. The safe optoelectronic sensor in accordance with claim 5, wherein the control and evaluation unit is configured to monitor changing hazard areas for different machine states within a process routine.

7. The safe optoelectronic sensor in accordance with claim 1, wherein the control and evaluation unit is configured to provide at least one piece of additional information at the output interface, with the at least one piece of additional information comprising at least one further shortest distance from other sections of the closest object or other objects, an object position, a direction of movement, a speed, an object envelope, or an object cloud.

8. The safe optoelectronic sensor in accordance with claim 1, wherein the safe optoelectronic sensor is configured for a detection capacity in which objects from a minimum size onward are reliably detected, with only objects of the minimum size being considered for the determination of the shortest distance.

9. The safe optoelectronic sensor in accordance with claim 8, wherein the control and evaluation unit is configured to define hazard areas in the form of at least one sphere covering the machine.

10. The safe optoelectronic sensor in accordance with claim 8, wherein the control and evaluation unit is configured to model objects as spheres having centers at the position of the object and radii corresponding to the minimum size corresponding to the detection capacity.

11. The safe optoelectronic sensor in accordance with claim 9, wherein the control and evaluation unit is configured to model objects as spheres having centers at the position of the object and radii corresponding to the minimum size corresponding to the detection capacity.

12. The safe optoelectronic sensor in accordance with claim 1, wherein the control and evaluation unit is configured to add the projective shadow of the hazard area and/or of the object to said hazard area and/or object for the determination of the shortest distance.

13. The safe optoelectronic sensor in accordance with claim 12, wherein the control and evaluation unit is configured to model projective shadows as cones.

14. The safe optoelectronic sensor in accordance with claim 12, wherein the control and evaluation unit is configured, for the determination of the shortest distance, to add only the projective shadow of the object to said object when the object is located closer to the safe optoelectronic sensor than the hazard area and, conversely, to add only the projective shadow of the hazard area to said hazard area when the hazard area is located closer to the safe optoelectronic sensor.

15. The safe optoelectronic sensor in accordance with claim 12, wherein the control and evaluation unit is configured, for the determination of the shortest distance, to model the respective closer partner of a pair of hazard area and object in the form of a first sphere together with the cone as a project shadow and to model the more remote partner as a second sphere.

16. The safe optoelectronic sensor in accordance with claim 15, wherein the control and evaluation unit is configured to use a sectional plane that is defined by the position of the safe optoelectronic sensor, the center of the first sphere, and the center of the second sphere for the determination of the shortest distance.

17. An arrangement of at least one safe optoelectronic sensor and of a control, the safe optoelectronic sensor being provided to secure a monitored zone, the monitored zone comprising at least one secured machine that forms a hazard area having:
a light receiver for generating a received signal from received light from the monitored zone;
a control and evaluation unit for detecting object positions in the monitored zone from the received signal; and
a safe output interface for information acquired from the object positions, wherein the control and evaluation unit is configured to determine the shortest distance between the hazard area and object positions and to provide the shortest distance at the safe output interface; and the control being connected to the output interface and to the secured machine, wherein the control is configured to evaluate shortest distances provided by the safe optoelectronic sensor and to initiate a safety directed response as required.

18. A method of securing a monitored zone comprising at least one machine that forms a hazard area, wherein a received signal is generated and evaluated from received light from the monitored zone to detect object positions in the monitored zone, and wherein information acquired from the object positions is reliably output,
wherein the shortest distance between the hazard area and the object positions is determined and is provided as safe information.
